(19) United States
(12) Patent Application Publication
(10) Pub. No.: US 2006/0170961 A1
(43) Pub. Date: Aug. 3, 2006

(54) Production management apparatus, production management method, program, and document production system

(75) Inventors: Ikune Saijo, Kyoto (JP); Masahiro Takemoto, Kyoto (JP); Hiroshi Nishide, Kyoto (JP); Masayuki Ichikawa, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/331,173

(22) Filed: Jan. 13, 2006

(30) Foreign Application Priority Data
Jan. 28, 2005 (JP) JP2005-020478
Dec. 7, 2005 (JP) JP2005-353575

(51) Int. Cl. G06F 3/12

(52) U.S. Cl. 358/1.15

(57) ABSTRACT

A construction information extraction section acquires information about a construction of a document from order information about document production acquired by an order information acquisition section. A job definition section defines jobs for producing a component, based on the construction information, and also defines stages to be executed in each of the jobs. A job assignment section assigns the defined jobs to job workers. A progress management section acquires information about progress on each of the stages included in the jobs assigned to the job workers. This achieves production management adapted to the realities at the site of actual production such that each job for the production of the document is subdivided into a plurality of parts which in turn are assigned to the job workers.

### BACKGROUND OF THE INVENTION

1. Field of the Invention

The present invention relates to a production management apparatus, a production management method, a program, and a document production system for management of a production status of a product including a document and the like and, more particularly, to those for managing a job including stages and required for the production on a stage-by-stage basis.

2. Description of the Background Art

For the production of a product such as a document and the like, production management is conventionally performed by causing the processing statuses of stages of a job to be sequentially updated and reported, while the job to be executed is defined based on order information and the product, and the stages for the execution of the job are executed in order. Specifically, a job worker to which a job is assigned updates and reports the starting and ending times of stages specified for the execution of the job, so that the processing status for the job is managed. In some cases, the processing status is precisely managed by using a tool such as a daily job report as disclosed, for example, at “http://konicaminolta.jp/products/industrial/graphic/neostream_pro/example.html.”

Recently, studies have been carried out on defining jobs for each of the components of the product by using JDF (Job Definition Format) as disclosed at “http://www.cip4.org/documents/jdf_specifications/JDF1.2.pdf.”

In contrast to such production management using each job constituting a product as a unit, it is a practice at the site of actual production of a product to subdivide a job used as a unit of production management into a plurality of parts which in turn are assigned to job workers. Because it is difficult to exercise the production management using a job as a unit so as to adapt to the realities, there arises working time for compensating for such a discrepancy in the process of production management.

### SUMMARY OF THE INVENTION

The present invention is intended for a production management apparatus for managing a production status of a product including a document and the like. More particularly, the present invention is intended for a production management apparatus for managing a job including stages and required for the production on a stage-by-stage basis.

According to the present invention, the production management apparatus for managing the production of a document comprises: a specification information acquisition element for acquiring predetermined specification information about a description of specifications of a document; a construction information extraction element for analyzing the predetermined specification information to extract construction information about a construction of the document; a job definition element for defining at least one job to be executed for the production of the document and at least one stage to be processed in the at least one job, the at least one job being defined in corresponding relation to a component constituting the document, based on the construction information; a job assignment element for assigning the at least one job defined by the job definition element to at least one job worker; and a progress management element for managing progress on the production of the document on a stage-by-stage basis, the stage being defined by the job definition element, wherein a predetermined worker terminal provided in corresponding relation to the at least one job worker is capable of processing stages, defined by the job definition element, for a corresponding job assigned to the at least one job worker, and wherein the progress management element acquires information about progress on each of the stages defined for the corresponding job from the predetermined worker terminal.

Thus, the progress of a job assigned to each job worker can be grasped for each stage defined for the job. This achieves production management adapted to the realities at the site of actual production such that each job for the production of the document is subdivided into a plurality of parts which in turn are assigned to the job workers.

It is therefore an object of the present invention to provide a production management apparatus which achieves production management adapted to the realities at the site of actual production.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a construction of a production system;

FIG. 2 illustrates a construction of a production management apparatus;

FIG. 3 illustrates an operation of the production management apparatus in the production system;

FIGS. 4A and 4B illustrate order information;

FIG. 5 illustrates components of a document;

FIG. 6 illustrates jobs defined for the production of each of the components;

FIG. 7 illustrates stages defined for the jobs for the production of each of the components of the document;

FIGS. 8A and 8B illustrate an association established between stages;

FIG. 9A illustrates a GUI for use in the creation of job responsibility information on a worker terminal;

FIG. 9B illustrates a structure of the job responsibility information;

FIG. 10 illustrates a job responsibility table created by a stage assignment section;

FIG. 11 illustrates a job assignment table created by the stage assignment section;

FIGS. 12A, 12B and 12C illustrate structures of job assignment information sent to a worker terminal;

FIG. 13 illustrates a job assignment menu on a worker terminal;

FIG. 14 illustrates a stage management table; and

FIG. 15 illustrates a modification.

### DESCRIPTION OF THE PREFERRED EMBODIMENT

A preferred embodiment according to the present invention will now be described with reference to the drawings.

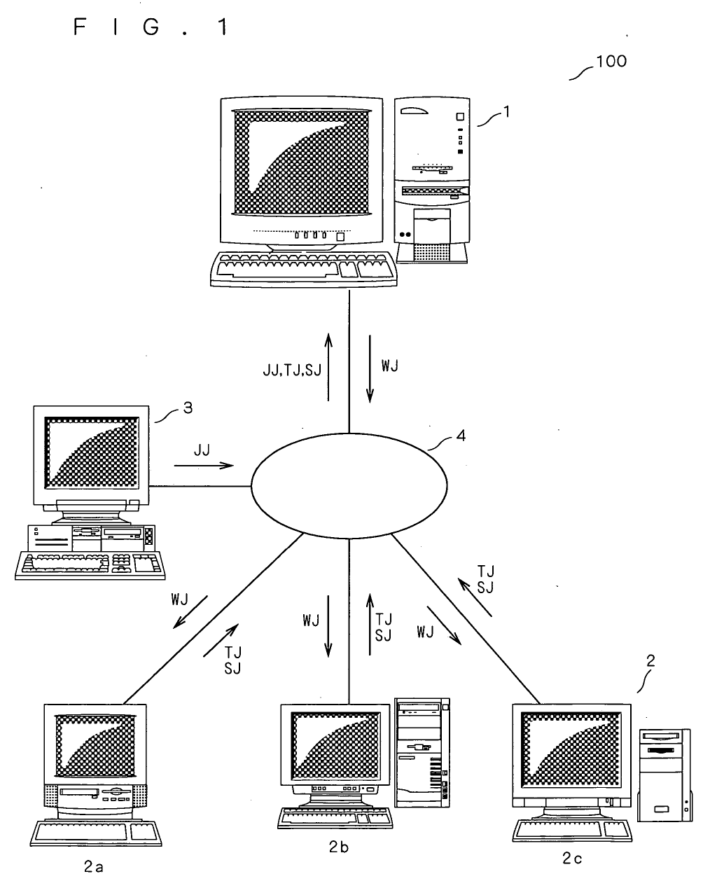

FIG. 1 illustrates a construction of a production system 100 according to the preferred embodiment of the present invention. The production system 100 is a system for the production of a document to be printed as printed matter, and comprises a production management apparatus 1, a plurality of worker terminals 2a, 2b and 2c (generically referred to also as worker terminals 2), an order entry terminal 3, and a network 4.

The production management apparatus 1 is connected for communication with the plurality of worker terminals 2 and the order entry terminal 3 by way of the network 4. The production management apparatus 1 receives order information JJ (to be detailed later) sent from the order entry terminal 3 to extract construction information about the construction of a document. The production management apparatus 1 also receives job responsibility information TJ (to be detailed later) sent from each of the worker terminals 2 to acquire information regarding each of the worker terminals 2, and sends to each of the worker terminals 2 job assignment information WJ (to be detailed later) for assigning jobs for the production of components of the document to job workers (or operators of the respective worker terminals 2). The production management apparatus 1 also receives job progress information SJ (to be detailed later) about stages included in each of the assigned jobs, which is sent from each of the worker terminals 2, to manage document production to be performed in the production system 100 based on the job progress information SJ.

Each of the worker terminals 2 has at least one of the various functions required during the production of the document. Job workers perform processing based on the various functions through the respective worker terminals 2, so that the production of the document is accomplished. The worker terminals 2 are connected for communication with the production management apparatus 1 by way of the network 4. The worker terminals 2 receive the job assignment information WJ sent from the production management apparatus 1, and send the job responsibility information TJ and the job progress information SJ to the production management apparatus 1.

In the production system 100 illustrated in FIG. 1, the three worker terminals 2a, 2b and 2c are connected to the production management apparatus 1 by way of the network 4. It is assumed that the worker terminals 2a, 2b and 2c have the following functions (not shown): the worker terminal 2a includes a scanner for the input of an image, and an image processing application for processing the inputted image; the worker terminal 2b includes layout application software for doing page layout to provide an output in a page description language format; and the worker terminal 2c includes rasterization software for converting a page description language into an image, and a proofer for outputting the rasterized image. The worker terminals 2a, 2b and 2c are capable of communication with each other by way of the network 4. Image data processed by the worker terminal 2a is sent to the worker terminal 2b, and subjected to the page layout in the worker terminal 2b. The page layout created in the page description language format by the worker terminal 2b is sent to the worker terminal 2c, subjected to the rasterization process in the worker terminal 2c, and is outputted by the proofer.

Although the three worker terminals 2 are shown in FIG. 1, the number of worker terminals 2 is not limited to three.. Additionally, all of the worker terminals 2a, 2b and 2c may have the functions of executing the image processing, the layout and the rasterization process.

The order entry terminal 3 is used to create the order information JJ containing information indicative of specifications of the document required to be produced by the production system 100. The order entry terminal 3 is also connected for communication with the production management apparatus 1 by way of the network 4. The order information JJ created by the order entry terminal 3 is sent to the production management apparatus 1. In addition to the order information JJ, contents information for the production of the document may be sent from the order entry terminal 3 by way of the network 4 to the worker terminals 2.

Although the single order entry terminal 3 is shown in FIG. 1, the number of order entry terminals 3 is not limited to one. The order entry terminal 3 is required to be connected to the network 4 only when sending the order information JJ to the production management apparatus 1, and need not stay connected to the network 4 all the time.

The network 4 connects the production management apparatus 1, the worker terminals 2 and the order entry terminal 3 to each other for communication therebetween. Examples of the network 4 used herein may include a generally used LAN and WAN, and the Internet.

Although the network 4 shown in FIG. 1 is a ring network, the network 4 may be a star network or a hub network. Additionally, the network 4 is not limited to a wired network, but may be a wireless network.

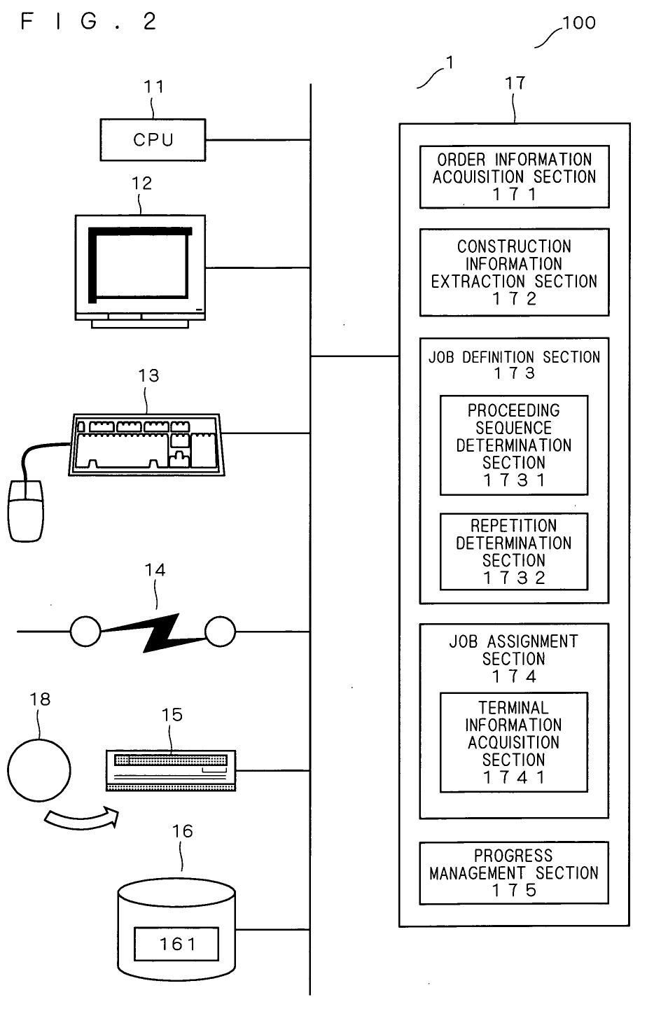

FIG. 2 illustrates a construction of the production management apparatus 1 according to the present invention. The production management apparatus 1 is a generally used personal computer including a CPU 11, a display section 12, an input section 13, a network I/F 14, a media drive 15, a storage section 16, and a memory 17.

The CPU 11 controls the entire production management apparatus 1. In particular, the CPU 11 executes in the memory 17 a program 161 recorded on a media disc 18 inserted in the media drive 15 to implement the functions of the production management apparatus 1. The display section 12 is used to present thereon information necessary for the production management of a document. The input section 13 includes a mouse and a keyboard, and is used by an operator entering a command into the production management apparatus 1. The network I/F 14 is provided to connect the production management apparatus 1 and the network 4 to each other. Through the network I/F 14, the production management apparatus 1 receives the order information JJ from the order entry terminal 3 connected to the network 4, sends the job assignment information WJ to the worker terminals 2, and also receives the job responsibility information TJ and the job progress information SJ from the worker terminals 2. The program 161 for implementing the functions of the production management apparatus 1 may be downloaded from a server not shown through the network I/F 14. The media drive 15 is used to read the program 161 recorded on the media disc 18. The storage section 16 stores therein the program 161 read by the media drive 15.

The memory 17 is a work area in which the CPU 11 executes the program 161 stored by the storage section 16. In consequence of the execution of the program 161 by the CPU 11, the functions of an order information acquisition section 171, a construction information extraction section 172, a job definition section 173, a job assignment section 174 and a progress management section 175 are implemented in the memory 17.

The order information acquisition section 171 acquires the order information JJ sent from the order entry terminal 3 by way of the network 4. The order information JJ acquired by the order information acquisition section 171 is used in the construction information extraction section 172 to extract the construction information about the construction of the document.

The construction information extraction section 172 extracts the construction information about the document (or information specifying what components construct the document) from the order information JJ. The order information JJ contains the information about the specifications of the document, and therefore the construction information extraction section 172 analyzes the order information JJ to extract the construction information about the document.

The job definition section 173 defines jobs for producing a component of interest, based on the construction information extracted by the construction information extraction section 172. The job definition section 173 also defines stages to be executed in each of the jobs. In the production management apparatus 1, the stages thus defined are handled as a unit for management of the progress of each of the jobs. When the document is composed of a plurality of components, required jobs and stages to be executed in each of the jobs are defined for each of the components. The job definition section 173 is also responsible for the process of establishing an association between the stages. Thus, the plurality of stages to be executed in one of the worker terminals 2 are in association with each other. Specifically, the job definition section 173 establishes an association between the stages in such a manner that, until one stage is completed for a job on one of the worker terminals 2, a transition to the next stage is not permitted or that, until one job is completed, a transition to the next job is not permitted.

For the definition of stages included in each job, the job definition section 173 includes a proceeding sequence determination section 1731 and a repetition determination section 1732.

The proceeding sequence determination section 1731 defines a plurality of stages included in a job in accordance with a sequence in-which the stages are to proceed, based on the fact that, in general, a plurality of stages are processed in a predetermined proceeding sequence in a job executed for the production of a document.

Based on the need to repeat the processing containing the same details twice or three times for reasons to be described later depending on the type of job, the repetition determination section 1732 defines a plurality of stages for a job required as such, so that the processing containing the same details is repeated for the plurality of stages.

The job assignment section 174 assigns jobs to respective job workers who use the worker terminals 2 to execute the jobs. The above-mentioned assignment is performed based on the job responsibility information TJ sent from the worker terminals 2 and what is defined by the job definition section 173 (more particularly, the proceeding sequence determination section 1731 and/or the repetition determination section 1732), by sending the job assignment information WJ to the worker terminals 2.

If the job responsibility information TJ is not sent from the worker terminals 2, the job assignment section 174 can assign the jobs to the job workers. To this end, the job assignment section 174 includes a terminal information acquisition section 1741. The terminal information acquisition section 1741 acquires information about the document production function of the worker terminals 2 as the job responsibility information TJ. Specifically, the terminal information acquisition section 1741 acquires information about application programs installed in a storage section not shown in each of the worker terminals 2. If a program applicable to the production of the document is stored in the storage section, the terminal information acquisition section 1741 creates the job responsibility information TJ so indicating. By referencing the job responsibility information TJ, the job assignment section 174 can assign the jobs executable by the worker terminals 2 to the job workers of the worker terminals 2, respectively.

The progress management section 175 receives the job progress information SJ sent from each of the worker terminals 2, and is responsible for a process for managing the progress of a job executed by each of the worker terminals 2 on a stage-by-stage basis, based on the job progress information SJ. When information about the processing start of one stage is received as the job progress information SJ from one of the worker terminals 2, the progress management section 175 handles the one stage as a stage the processing of which is started but is not completed. On the other hand, when information about the completion of one stage is received as the job progress information SJ from one of the worker terminals 2, the progress management section 175 handles the one stage as a stage the processing of which is completed. When no information about the processing of one stage is received after the stage is assigned to one job worker, the progress management section 175 handles the stage as an unprocessed stage.

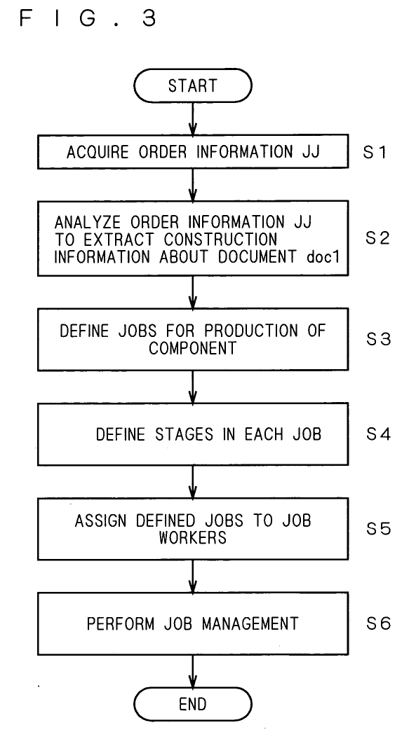

FIG. 3 is a flow chart for illustrating the operation of the production management apparatus 1 in the production system 100.

For the document production in the production system 100, the order information JJ is first sent from the order entry terminal 3, and the production management apparatus 1 receives the order information JJ by way of the network 4 (in Step S1). The order information JJ is acquired by the order information acquisition section 171 of the production management apparatus 1, and is used for subsequent processes.

When the order information acquisition section 171 receives the order information JJ, the construction information extraction section 172 analyzes the order information JJ to extract the construction information about the document to be produced (in Step S2).

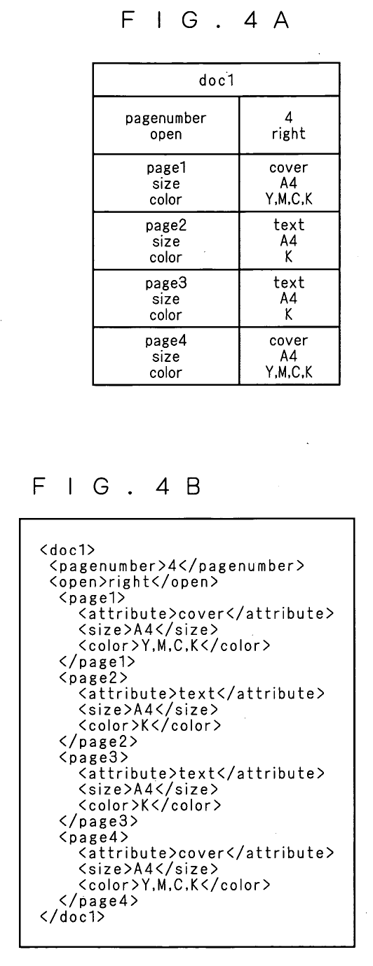

FIGS. 4A and 4B illustrate the order information JJ. FIG. 4A illustrates the specifications of a document doc1 as an example for which the order information JJ is created. As shown in FIG. 4A, the specifications of the document doc1 are determined so that the document doc1 contains four pages in “A4” size, and so that the first and fourth pages corresponding to covers are printed with four colors of Y, M, C and K (or printed as color pages) and the second and third pages corresponding to text are printed in black and white (or printed as black-and-white pages).

FIG. 4B illustrates the order information JJ about the document doc1. The order information JJ is described, for example, in a tagged text format such as XML (extensible Markup Language) as shown in FIG. 4B. The construction information extraction section 172 of the production management apparatus 1 analyzes the order information JJ thus described to extract the construction information.

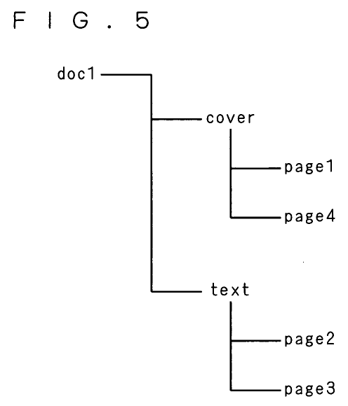

FIG. 5 illustrates components constituting the document doc1. The construction information extraction section 172 references the location of the “attribute”tag described for each page in the order information JJ to acquire the construction information as shown in FIG. 5. FIG. 5 shows that acquired is the construction information indicating that the document doc1 is composed of the components: “cover” and “text”. Based on the order information JJ shown in FIG. 4B, the component “cover” is produced as the color pages whereas the component “text” is produced as the black-and-white pages. There is a difference in the number of inks for use in printing between the color pages and the black-and-white pages. Another difference between the color pages and the black-and-white pages lies in the details of the page layout because the former are used as the covers of the document and the latter as the text thereof. Therefore, the two components are produced through different jobs.

Referring again to FIG. 3, after the construction information extraction section 172 extracts the construction information, the job definition section 173 defines jobs required to produce the document corresponding to the construction information, based on the construction information (in Step S3).

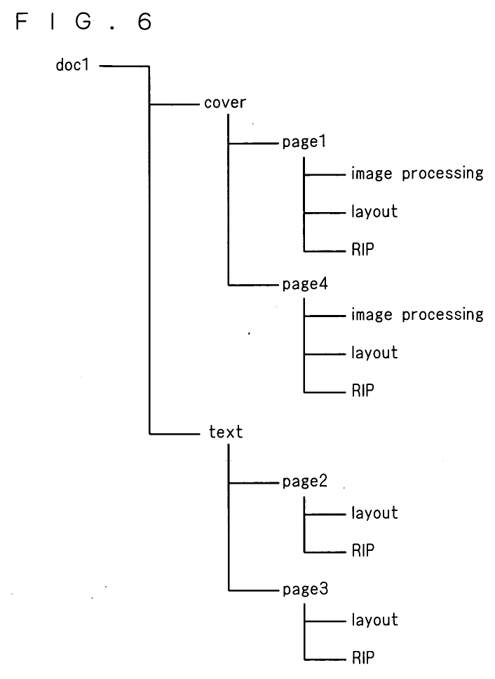

FIG. 6 shows that the jobs for the production of the components of the document doc1 shown in FIG. 5 are defined for each of the components by the job definition section 173. Because “page1” and “page4” included in the component “cover” among the components of the document doc1 are determined in the order information JJ so as to be produced as color pages, the production of each of these pages requires the job of processing a color image, the job of doing page layout, and the job of performing the rasterization process. The job definition section 173 defines these three jobs as those for the production of the component “cover” under the names of “image processing,” “layout” and “RIP,” respectively. Similarly, because “page2” and “page3” included in the component “text” are determined in the order information JJ so as to be produced as black-and-white pages, the production of each of these pages requires the job of doing page layout and the job of performing the rasterization process. The job definition section 173 defines two jobs under the names of “layout” and “RIP” for the component “text.”

Referring again to FIG. 3, the job definition section 173 defines stages to be executed in each of the jobs (in Step S4). The stages to be executed in each of the jobs refer to the processes actually performed by a job worker using one of the worker terminals 2 for the execution of each of the jobs. It means the completion of the execution of a job that a job worker to which the job is assigned processes the stages defined for the job by the job definition section 173 by using one of the worker terminals 2.

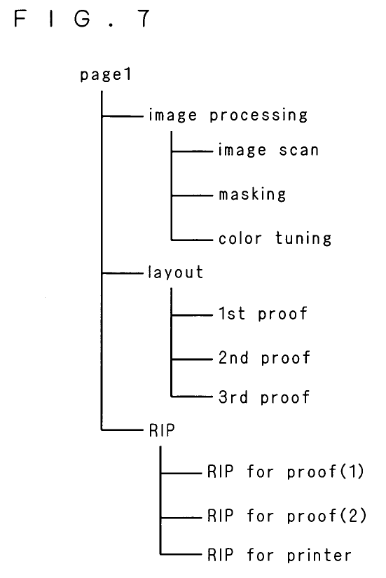

FIG. 7 shows that the stages are defined by the job definition section 173 for each of the jobs for the production of “page1” of the component “cover” of the document doc1.

With reference to FIG. 7, stages named “image scan,” “masking” and “color tuning” are defined for the job “image processing” for the production of “page1.” These stages correspond to the process of inputting an image, the process of cutting out the inputted image, and the process of performing color tuning on the cut-out image. These stages are defined by the proceeding sequence determination section 1731 so as to be executed in the job “image processing.” Because the cutting out and the color tuning cannot be executed without the input of an image, the proceeding sequence determination section 1731 establishes a definition so that the stage “image scan” is executed as the first stage of the job “image processing.” In general, the color tuning is performed after the process of cutting out an image. Thus, the proceeding sequence determination section 1731 subsequently defines the stages “masking” and “color tuning” in this sequence.

On the other hand, stages named “1st proof,” “2nd proof” and “3rd proof” are defined for the job “layout” for the production of “page1.” Such a definition is established by the repetition determination section 1732 so that the stage for performing the layout process is repeated. This definition reflects the realities of typical production of printed matter such that a customer who places an order for printed matter judges whether the produced printed matter is acceptable or not and the layout can be redone a plurality of times. Shown in FIG. 7 is an instance where the repetition determination section 1732 establishes a definition so that the stage “first proof” for performing the first layout process, the stage “2nd proof” for performing the layout process as the first correction, and the stage “3rd poof” for performing the layout process as the second correction are executed for the job “layout.”

Stages named “RIP for proof (1),” “RIP for proof (2)” and “RIP for printer” are defined for the job “RIP” for the production of “page1.” Such a definition means that there is a stage for proof printing of an image obtained as a result of the rasterization process. Shown in FIG. 7 is an instance where the repetition determination section 1732 establishes a definition so that the stage “RIP for proof (1)” for performing the first rasterization process and the first proof printing process, the stage “RIP for proof (2)” for performing the second rasterization process and the second proof printing process upon “page1” subjected to the stage “2nd proof” of the job “layout,” and the stage “RIP for printer” for performing the rasterization process for final printing and the final printing process on condition that approval is received from the customer based on the result of the second proof printing are executed for the job “RIP.”

The job definition section 173 defines stages included in the defined jobs similarly for “page4” included in the component “cover” and for “page2” and “page3” included in the component “text.”

In Step S4, the job definition section 173 also establishes an association between the plurality of defined stages. In the jobs of producing a component, there arises a situation where a transition from one stage to the next stage is not permitted until the processing of the one stage is completed or a situation where a transition from one job to the next job is not permitted until the one job is completed. Thus, the job definition section 173 establishes a predetermined association between the plurality of stages defined by the proceeding sequence determination section 1731 so as to allow the progress management such that, when the processing in one stage is completed, a transition to the next stage is made. Such an association between the stages are initially defined in the job definition section 173, based on typical stage processing.

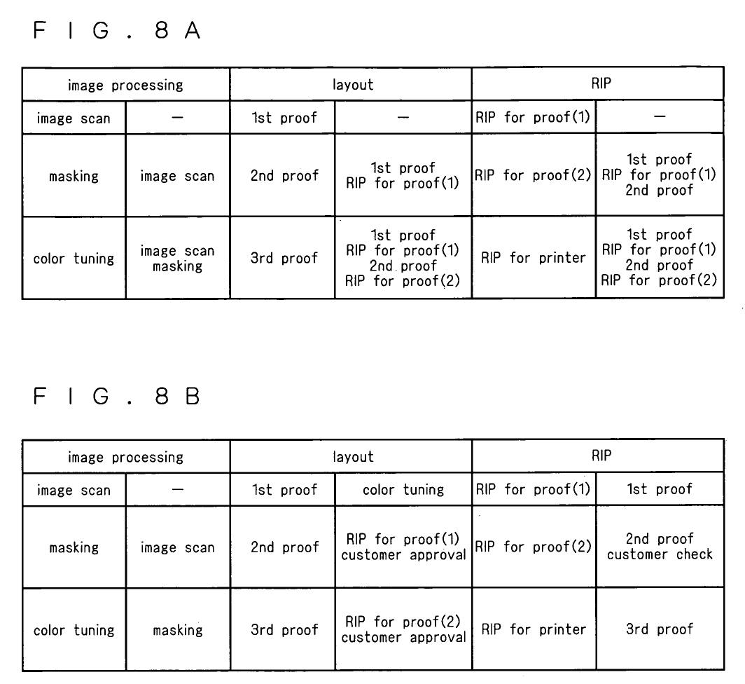

FIGS. 8A and 8B show that an association is established between the stages by the job definition section 173 for each of the jobs “image processing,” “layout” and “RIP” for the production of “page1” included in the component “cover” of the document doc1.

For the job “image processing,” the stages “image scan,” “masking” and “color tuning” are processed in this sequence. Thus, the stages are defined by the proceeding sequence determination section 1731, based on this sequence. As shown in FIG. 8A, the job definition section 173 accordingly associates the stage “image scan” with the stage “masking.” This causes the progress management for the job “image processing” so that the processing of the stage “masking” is not started until the processing of the stage “image scan” is completed.

For the job “layout,” the stages are defined by the repetition determination section 1732, and the job definition section 173 establishes an association between these stages. For example, the stage “2nd proof” is a stage to be executed after the customer checks up on a proof sheet outputted in the stage “RIP for proof (1)” included in the job “RIP” after the stage “1st proof.” The job definition section 173 accordingly associates not only the stage “1st proof” but also the stage “RIP for proof (1)” defined for the job “RIP” with the stage “2nd proof,” as shown in FIG. 8A. In this manner, the job definition section 173 can establish associations not only between stages within the same job but also between stages in different jobs.

The associations between the stages by the job definition section 173 may be made definable by an operator of the production management apparatus 1 at will. FIG. 8B illustrates such an instance. For example, the job “image processing” and the job “layout” for the production of “page1” included in the component “cover” of the document doc1 may be executed in parallel with each other. However, if the operator of the production management apparatus 1 associates the stage “color tuning” included in the job “image processing” with the stage “1st proof” included in the job “layout” as shown in FIG. 8B, the production management for the proceeding of the jobs such that a transition is made to the job “layout” after the completion of the job “image processing” can be carried out. Similarly, if the operator associates the stage “1st proof” included in the job “layout” with the stage “RIP for proof (1)” included in the job “RIP,” the production management for the proceeding of the jobs in such a sequence that the stage “RIP for proof (1)” of the job “RIP” is executed after the completion of the stage “1st proof” of the job “layout” can be carried out. In this manner, detailed production management can be accomplished by allowing the operator of the production management apparatus 1 to define the associations between the stages at will.

With reference to FIG. 8B, the stage “customer approval” is associated with the stage “2nd proof” of the job “layout,” and the stage “customer check” is associated with the stage “RIP for proof (2)” of the job “RIP.” The stages “customer approval” and “customer check” are not responsible for the document production itself but are customary stages for the production. The job definition section 173 can associate such stages. For example, the former association means that the stage “customer approval” in which the product customer approves the first revise (or the first printed matter for proofing) obtained in the stage “1st proof” is required prior to the execution of the stage “2nd proof.” Thus, more detailed production management can be accomplished by allowing the job definition section 173 to establish an association in consideration for the customary practice in the production.

Referring again to FIG. 3, the job assignment section 174 of the production management apparatus 1 assigns the jobs for the production of each component of the document to job workers (in Step S5). To this end, the production management apparatus 1 receives the job responsibility information TJ sent from each of the worker terminals 2 to acquire information about the worker terminals 2 and the job workers who use the worker terminals 2.

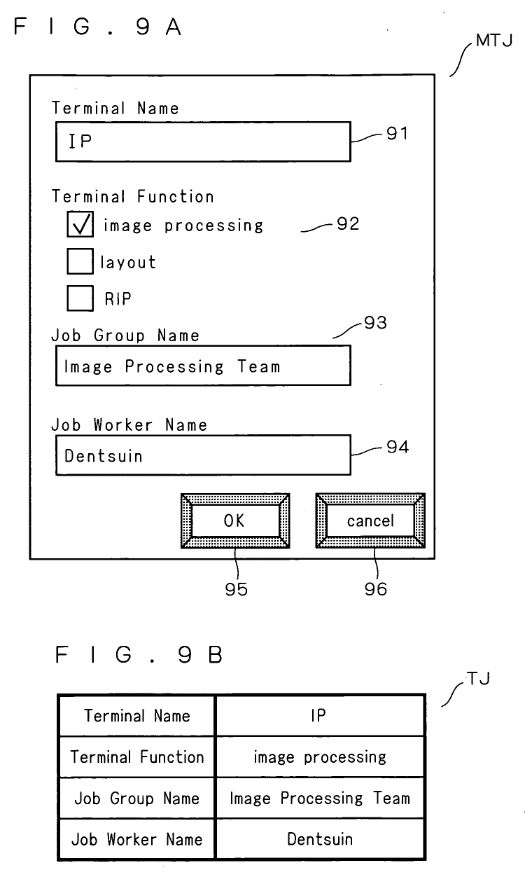

FIGS. 9A and 9B illustrate a GUI (Graphical User Interface) used for the creation of the job responsibility information TJ on the worker terminals 2, and a structure of the job responsibility information TJ.

FIG. 9A shows a job responsibility information acquisition menu MTJ displayed on a display section (not shown) of any one of the worker terminals 2. The job responsibility information TJ created by using the job responsibility information acquisition menu MTJ is acquired by the job assignment section 174.

The job responsibility information acquisition menu MTJ includes a terminal name input box 91, a terminal function input area 92, a job group name input box 93, a job worker name input box 94, an OK button 95 and a cancel button 96.

The terminal name input box 91 is provided for the entry of the name of the terminal through which a job is to be executed. The terminal function input area 92 is provided for the entry of a function executable for the production of a component of the document in the terminal, and allows the selection of a plurality of functions. The job group name input box 93 is provided for the entry of the name of a group to which a job worker at his/her workplace belongs. The job worker name input box 94 is provided for the entry of the name of a job worker who manipulates the corresponding worker terminal 2 to execute the job. The job worker presses the cancel button 96 to cancel the entry into the job responsibility information acquisition menu MTJ.

When the job worker uses an input section (not shown) of the worker terminal 2 to make an entry into the job responsibility information acquisition menu MTJ and then presses the OK button 95, the entry is sent as the job responsibility information TJ to the production management apparatus 1.

FIG. 9A illustrates entries made into the job responsibility information acquisition menu MTJ on the worker terminal 2a. The terminal name “IP” is entered in the terminal name input box 91. In the terminal function input area 92, “image processing” is selected by placing a checkmark in a corresponding checkbox. A group name “image processing team” is entered in the job group name input box 93. A job worker name “Dentsuin” is entered in the job worker name input box 94. In this case, the job responsibility information TJ as shown in FIG. 9B is created in the worker terminal 2a, and is sent by way of the network 4 to the production management apparatus 1.

The job assignment section 174 need not acquire the job responsibility information TJ at Step S5, but may do so prior to the start of Step S1 or at any time between Steps S1 to S4. Alternatively, an e-mail message containing a description about the job responsibility information TJ in a predetermined form may be sent from the worker terminal 2 to the production management apparatus 1, whereby the job assignment section 174 acquires the job responsibility information TJ from the e-mail message.

The job assignment section 174 of the production management apparatus 1 references the job responsibility information TJ sent from each of the worker terminals 2 to assign the jobs to the worker terminals 2, respectively.

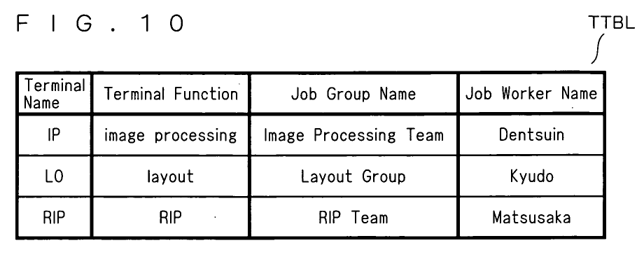

FIG. 10 illustrates a job responsibility table TTBL created by the job assignment section 174 referencing the job responsibility information TJ for the purpose of assigning the jobs for the production of a component to the worker terminals 2. The job responsibility table TTBL is formed by integrating the pieces of job responsibility information TJ sent from the respective worker terminals 2 together. The job responsibility table TTBL contains the functions of the worker terminals 2 constituting the production system 100, the names of the job groups which use the worker terminals 2, and the names of the job workers.

The job assignment section 174 references the details of the stages defined in the job definition section 173 and the job responsibility table TTBL to create a job assignment table WTBL for the production of a component of interest.

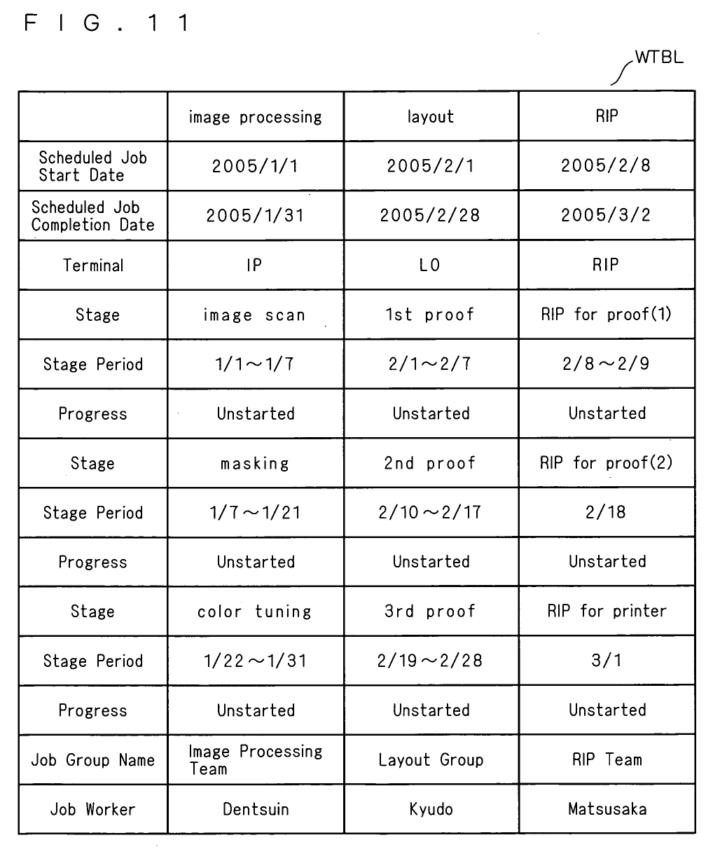

FIG. 11 illustrates the job assignment table WTBL created by the job assignment section 174. As shown in FIG. 11, the job assignment table WTBL contains descriptions of the following items: “scheduled job start date,” “scheduled job completion date,” “terminal,” “stage,” “stage period,” “job group,” “job worker name” and “progress” for each of the jobs “image processing,” “layout” and “RIP.” The operator of the production management apparatus 1 manipulates the input section 13 to make an entry for each of the items in the job assignment table WTBL. The “scheduled job start date” denotes the scheduled date for the start of a job for the production of the component, and the “scheduled job completion date” denotes the scheduled date for the completion of the job. The “stage period” denotes a period of day for which a stage defined for the job is to be executed. Because the job assignment table WTBL is created by reference to the job responsibility table TTBL, the items “terminal,” “job group,” and “job worker” have been already entered. The entry for the item “stage” is determined by establishing an association between information regarding the terminal function described in the job responsibility table TTBL and the stages defined for the job corresponding to the information.

When the job assignment table WTBL is just created, “unstarted” is entered for the item “progress” because all of the jobs have not yet started.

After the job assignment table WTBL is created, the job assignment section 174 references the job assignment table WTBL to create the job assignment information WJ, and sends the job assignment information WJ to the worker terminals 2 by way of the network 4. The job assignment section 174 sends the job assignment information WJ to the worker terminals 2 which can execute the stages defined for the jobs described in the job assignment table WTBL so as to cause the above-mentioned worker terminals 2 to execute the jobs including the stages.

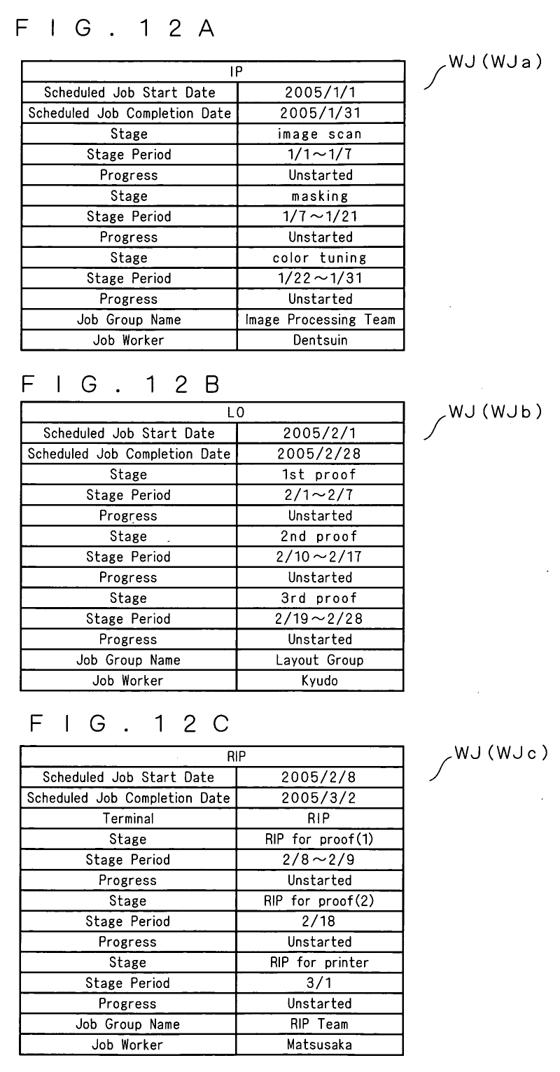

FIGS. 12A, 12B and 12C illustrate the job assignment information WJ (WJa, WJb and WJc) sent from the job assignment section 174 to the worker terminals 2a, 2b and 2c, respectively. Because the worker terminal 2a has a function regarding the image processing as its terminal function, the job assignment information WJa for the assignment of the job “image processing” as shown in FIG. 12A is sent from the job assignment section 174 to the worker terminal 2a. The job assignment information WJa contains information similar to that for the item regarding the job “image processing” in the job assignment table WTBL. Likewise, FIG. 12B shows the job assignment information WJb for the assignment of the job “layout” to the worker terminal 2b which executes a function regarding the layout, and FIG. 12C shows the job assignment information WJc for the assignment of the job “RIP” to the worker terminal 2c.

Although the job workers use the worker terminals 2 to send the job responsibility information TJ in the above description, the terminal information acquisition section 1741 may acquire information about the functions of producing the document on the worker terminals 2 to assign the jobs to the job workers based on the acquired information. In this case, the terminal information acquisition section 1741 gains access to a storage section (not shown) of each of the worker terminals 2 by way of the network 4 to acquire information about application programs installed in the storage section. If the storage section of any one of the worker terminals 2 stores a program applicable to the production of the document, the terminal information acquisition section 1741 acquires information about the program together with information for identifying the worker terminal 2 such as the IP address or MAC address assigned to the worker terminal 2 or the terminal name as the job responsibility information TJ. In such a configuration, the job assignment section 174 may perform processing similar to that described above to assign the stages executable by the production function of the worker terminal 2 to the job worker who uses the worker terminal 2.

When the terminal information acquisition section 1741 acquires the information about the production function of the worker terminal 2 and uses the job group name or the job worker name for the worker terminal 2 as the information for identifying the worker terminal 2, the job worker on the worker terminal 2 may be required only to send the job group name or the job worker name as the job responsibility information TJ to the job assignment section 174, thereby to enable the job assignment section 174 to assign the stages.

Referring again to FIG. 3, after the job assignment section 174 sends the job assignment information WJ to the worker terminal 2, a display section (not shown) of the worker terminal 2 displays a job assignment menu MWJ based on the job assignment information WJ. The progress management section 175 receives the job progress information SJ created in response to the display, whereby the management of the jobs for the production of the components of the document with the production management apparatus 1 is allowed (in Step S6).

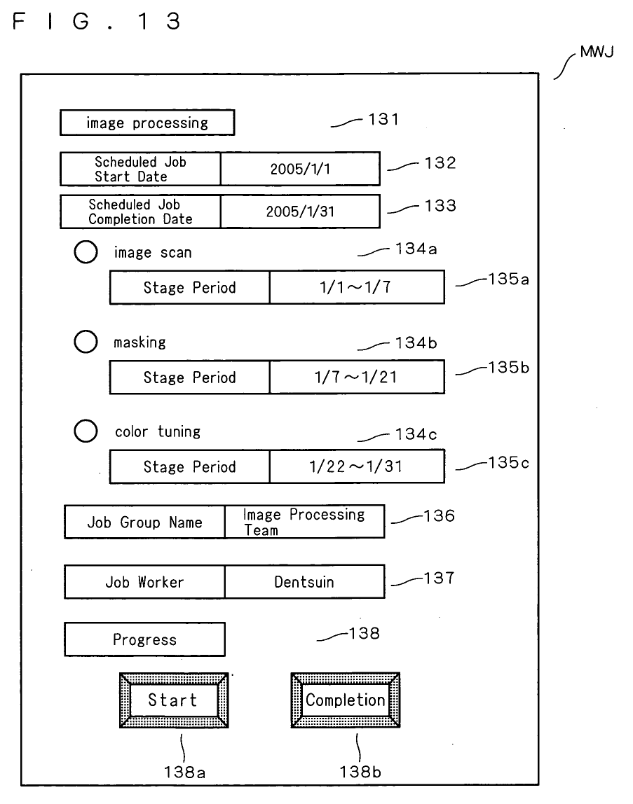

FIG. 13 illustrates the job assignment menu MWJ on the worker terminal 2a as an example of the job assignment menu MWJ displayed on the display sections (not shown) of the worker terminals 2. As shown in FIG. 13, the job assignment menu MWJ includes a job display area 131, a scheduled job start date display box 132, a scheduled job completion date display box 133, to-be-executed stage input areas 134a to 134c, stage period display boxes 135a to 135c, a job group display box 136, a job worker name display box 137, and a progress input area 138.

The job display area 131, the scheduled job start date display box 132 and the scheduled job completion date display box 133 present the descriptions of the corresponding items in the job assignment information WJ without any change.

The to-be-executed stage input areas 134a to 134c are provided for the entry of stages to be executed hereafter. The job worker places a checkmark in one of the to-be-executed stage input areas 134a to 134c by means of an input section not shown, thereby to select one stage. For example, a checkmark placed in the to-be-executed stage input area 134a results in the selection of the stage “image scan” as the stage to be executed hereafter.

The stage period display boxes 135a to 135c, the job group display box 136 and the job worker name display box 137 present the descriptions of the corresponding items in the job assignment information WJ without any change. Entries may be made into the job group display box 136 and the job worker name display box 137 on the worker terminal 2. If there is a change in job group and/or in job worker, the job group in the job group display box 136 and/or the job worker name in the job worker name display box 137 may be changed by manipulating the input section not shown.

The progress input area 138 is an item for the entry of the progress of the selected stage. The progress input area 138 includes a stage start button 138a and a stage completion button 138b. When the stage start button 138a is pressed by means of the input section not shown at the start of the processing of the selected stage, information indicating that the selected stage is started is provided. On the other hand, when the stage completion button 138b is pressed at the completion of the processing of the selected stage, information indicating that the selected stage is completed is provided.

When the job worker makes an entry into the job assignment menu MWJ, the entry is sent as the job progress information SJ to the progress management section 175 by way of the network 4. The progress management section 175 references the received job progress information SJ to create a stage management table KTBL.

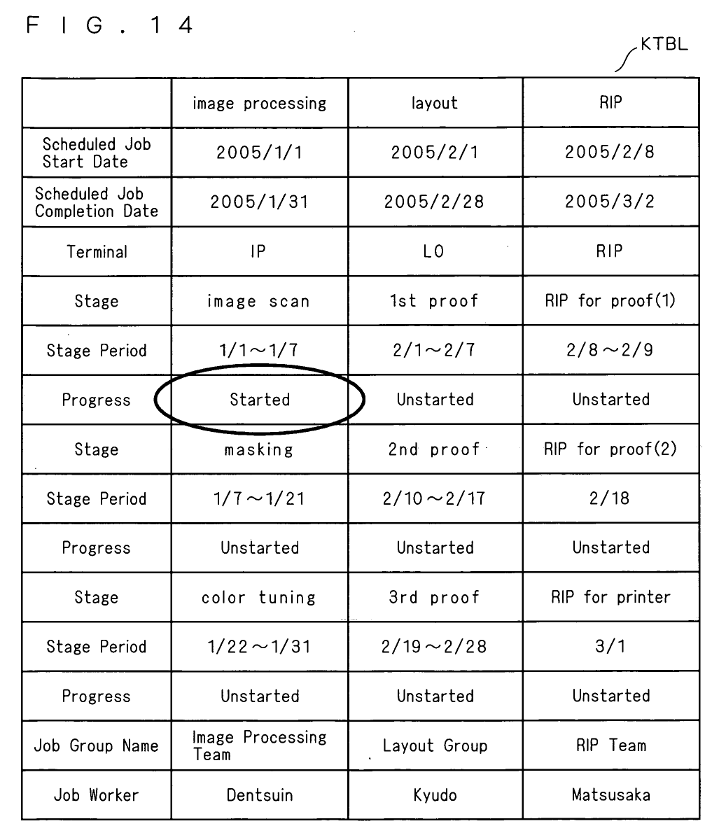

FIG. 14 illustrates the stage management table KTBL created by the progress management section 175. The stage management table KTBL is similar in construction to the job assignment table WTBL shown in FIG. 11. The stage management table KTBL may be created by copying the job assignment table WTBL created by the job assignment section 174. Upon receipt of the job progress information SJ from the worker terminal 2, the progress management section 175 reflects the received job progress information SJ in the entries for each item of the stage management table KTBL.

For example, if a change in the job worker who is responsible for the job “image processing” is described in the job progress information SJ, the entry for the item “job worker name” in the stage management table KTBL provided in corresponding relation to the item “job worker name” in the job assignment table WTBL is changed to a job worker name described in the job progress information SJ.

If there is a description about the “progress” of each job in the job progress information SJ, the entry for the item “progress” in the stage management table KTBL is changed based on the description. For example, if “started” is presented for the item “progress” of the stage “image scan” of the job “image processing” in the job progress information SJ, the progress management section 175 changes the description of the corresponding item in the stage management table KTBL from “unstarted” entered based on the item “progress” in the job assignment table WTBL to “started.”

If “completed” is presented for the item “progress” of the stage “image scan” of the job “image processing” in the job progress information SJ after the processing of the stage on the worker terminal 2a proceeds, the progress management section 175 changes the description of the corresponding item in the stage management table KTBL from “started” to “completed.”

The progress management section 175 performs such processing for the worker terminals 2a, 2b and 2c, whereby the jobs for the production of a component on the worker terminals 2 are managed using each stage included in the jobs as a unit by reference to the stage management table KTBL.

Therefore, the production management apparatus 1 shown in FIG. 2 performs the operation shown in the flow chart of FIG. 3 to achieve the production management adapted to the realities at the site of actual production such that each job is subdivided into a plurality of parts which in turn are assigned to the job workers.

### Modifications

A modification to be described below may be made to Step S6 according to the present invention.

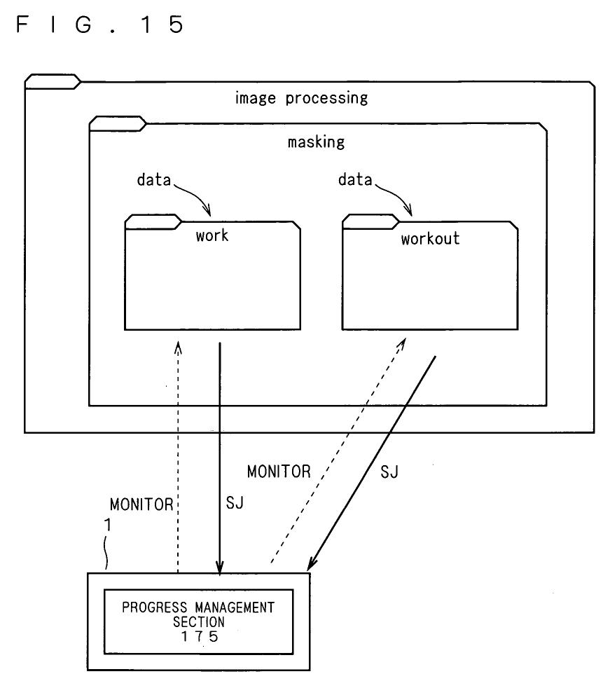

FIG. 15, shows folders displayed on the display section (not shown) of the worker terminal 2a for use in processing of the stages. These folders corresponds to a visualized directory structure on the worker terminal 2a. A folder named “masking” is located in a folder named “image processing.” A folder named “work” and a folder named “workout” are located in the folder named “masking.”

The folder “work” is a folder for the execution of the processing of a stage in response to the input of data required for the processing of the stage. The folder “workout” is a folder for storing processed data resulting from the completion of the processing of the stage in the folder named “work.”

The progress management section 175 monitors the input of data to these folders, thereby to acquire the job progress information SJ.

The folder “work” is a folder located in the folder “masking” which in turn is located in the folder “image processing” on the worker terminal 2. Thus, when predetermined data is inputted to the folder “work,” the progress management section 175 which monitors the folder “work” acquires information indicating that the processing to be performed in response to the input of the predetermined data is the processing of the stage “masking” included in the job “image processing.” That is, the progress management section 175 can acquire the job progress information SJ indicating that the stage “masking” included in the job “image processing” has started, based on the consideration that the input of the predetermined data to the folder “work” indicates the start of the processing of the stage “masking.”

When the processed data is inputted to the folder “workout” after the completion of the processing of the stage “masking” in the folder “work,” the progress management section 175 can acquire the job progress information SJ indicating that the stage “masking” of the job “image processing” is completed.

Such a configuration achieves the production management with the production management apparatus 1, adapted to the realities at the site of actual production such that each job is subdivided into a plurality of parts which in turn are assigned to the job workers.

Although only the worker terminals 2a, 2b and 2c are hereinabove described as used to execute the jobs, one or more additional worker terminals 2 may be used to process the jobs.

In the above description, the proceeding sequence determination section 1731 defines the stages for the job “image processing,” and the repetition determination section 1732 defines the stages for the job “layout.” However, the definitions may be established only by the proceeding sequence determination section 1731 or the repetition determination section 1732. Additionally, the stages may be defined by the proceeding sequence determination section 1731 and repetition determination section 1732 at the same time.

Although the description has been given hereinabove about the production system 100 as a system for producing a document for the printing of printed matter, the technical idea of the present invention is also applicable to the production of other products.

While the invention has been described in detail, the foregoing description is in all aspects illustrative and not restrictive. It is understood that numerous other modifications and variations can be devised without departing from the scope of the invention.

What is claimed is:

1. A production management apparatus for managing the production of a document, comprising:
a specification information acquisition element for acquiring predetermined specification information about a description of specifications of a document;
a construction information extraction element for analyzing said predetermined specification information to extract construction information about a construction of said document;
a job definition element for defining at least one job to be executed for the production of said document and at least one stage to be processed in said at least one job, said at least one job being defined in corresponding relation to a component constituting said document, based on said construction information;
a job assignment element for assigning said at least one job defined by said job definition element to at least one job worker; and
a progress management element for managing progress on the production of said document on a stage-by-stage basis, said stage being defined by said job definition element,
wherein a predetermined worker terminal provided in corresponding relation to said at least one job worker is capable of processing stages, defined by said job definition element, for a corresponding job assigned to said at least one job worker, and
wherein said progress management element acquires information about progress on each of said stages defined for said corresponding job from said predetermined worker terminal.

2. The production management apparatus according to claim 1, wherein
said job assignment element acquires information about a function of said predetermined worker terminal which is capable of executing one or each of jobs to be executed for the production of said document from said predetermined worker terminal to assign said jobs based on said information.

3. The production management apparatus according to claim 1, wherein
said job definition element also establishes an association between a plurality of stages when said plurality of stages are defined, and
said progress management element manages said progress based on the established association.

4. The production management apparatus according to claim 1, wherein
when defining a plurality of stages for at least one job, said job definition element establishes a definition based on a sequence in which said plurality of stages are to proceed.

5. The production management apparatus according to claim 1, wherein
when defining a plurality of stages for at least one job, said job definition element establishes a definition so that processing containing the same details is repeated for said plurality of stages.

6. A method of managing the production of a document, comprising the steps of:
a) acquiring predetermined specification information about a description of specifications of a document by a predetermined acquisition element;
b) analyzing said predetermined - specification information to extract construction information about a construction of said document by a predetermined extraction element;
c) defining at least one job to be executed for the production of said document and at least one stage to be processed in said at least one job by a predetermined definition element, said at least one job being defined in corresponding relation to a component constituting said document, based on said construction information;
d) assigning said at least one job defined in said step c) to at least one job worker by a predetermined assignment element; and
e) managing progress on said at least one job assigned to said at least one job worker in said step d) on a stage-by-stage basis by a predetermined management element, said stage being defined for said at least one job in said step c),
wherein a predetermined worker terminal provided in corresponding relation to said at least one job worker is capable of processing stages, defined in said step c), for a corresponding job assigned to said at least one job worker, and
wherein said predetermined management element acquires information about progress on each of said stages defined for said corresponding job from said predetermined worker terminal in said step e).

7. A program stored in a computer and executed in said computer to thereby cause said computer to function as a production management apparatus for managing the production of a document, said production management apparatus comprising:
a specification information acquisition element for acquiring predetermined specification information about a description of specifications of a document;
a construction information extraction element for analyzing said predetermined specification information to extract construction information about a construction of said document;
a job definition element for defining at least one job to be executed for the production of said document and at least one stage to be processed in said at least one job, said at least one job being defined in corresponding relation to a component constituting said document, based on said construction information;
a job assignment element for assigning said at least one job defined by said job definition element to at least one job worker; and
a progress management element for managing progress on the production of said document on a stage-by-stage basis, said stage being defined by said job definition element,
wherein a predetermined worker terminal provided in corresponding relation to said at least one job worker is capable of processing stages, defined by said job definition element, for a corresponding job assigned to said at least one job worker, and
wherein said progress management element acquires information about progress on each of said stages defined for said corresponding job from said predetermined worker terminal.

8. A document production system comprising:
a) at least one worker terminal having a function capable of executing one or each of jobs to be executed for the production of a document; and
b) a production management apparatus for managing the production of said document, said production management apparatus including:
b-1) a specification information acquisition element for acquiring predetermined specification information about a description of specifications of said document;
b-2) a construction information extraction element for analyzing said predetermined specification information to extract construction information about a construction of said document;
b-3) a job definition element for defining at least one job to be executed for the production of said document and at least one stage to be processed in said at least one job, said at least one job being defined in corresponding relation to a component constituting said document, based on said construction information;
b-4) a job assignment element for assigning said at least one job defined by said job definition element to at least one job worker; and
b-5) a progress management element for managing progress on the production of said document on a stage-by-stage basis, said stage being defined by said job definition element,
wherein said at least one worker terminal provided in corresponding relation to said at least one job worker is capable of processing stages, defined by said job definition element, for a corresponding job assigned to said at least one job worker, and
wherein said progress management element acquires information about progress on each of said stages defined for said corresponding job from said at least one worker terminal.

9. The document production system according to claim 8, wherein
said job assignment element acquires information about said function from said at least one worker terminal to assign said jobs based on said information.
